(19) United States
(12) Patent Application Publication
(10) Pub. No.: US 2006/0182149 A1
(43) Pub. Date: Aug. 17, 2006

(54) Method and system for mobile multimedia processor supporting rate adaptation and mode selection

(76) Inventor: Timothy James Ramsdale, Cambridge (GB)

Correspondence Address: MCANDREWS HELD & MALLOY, LTD, 500 WEST MADISON STREET, SUITE 3400, CHICAGO, IL, 60661, US

(21) Appl. No.: 11/351,918

(22) Filed: Feb. 10, 2006

Related U.S. Application Data
(60) Provisional application No. 60/652,429, filed on Feb. 12, 2005.

(51) Int. Cl. H04J 3/06

(52) U.S. Cl. 370/516

(57) ABSTRACT

Aspects for a method and system for a mobile multimedia processor supporting rate adaptation and mode selection are provided. A method for a mobile multimedia processor supporting rate adaptation and mode selection may comprise latching a received address signal at a received clock rate via a received write enable signal. The received clock rate may be converted to a latched clock rate, and a latched address signal may be generated at the latched clock rate via a latched write enable signal. A system for a mobile multimedia processor supporting rate adaptation and mode selection may comprise circuitry that latches a received address signal at a received clock rate via a received write enable signal. The received clock rate may be converted, by the circuitry, to a latched clock rate. A latched address signal may be generated at the latched clock rate via a latched write enable signal.

### CROSS-REFERENCE TO RELATED APPLICATIONS/INCORPORATION BY REFERENCE

This application makes reference to, claims priority to, and claims benefit from U.S. Provisional Patent Application Ser. No. 60/652,429 filed on Feb. 12, 2005.

This application make reference to:
U.S. patent application Ser. No. ______ (Attorney Docket No. 16430US02) filed Jan. 19, 2006;
U.S. patent application Ser. No. ______ (Attorney Docket No. 16432US02) filed Jan. 19, 2006;
U.S. patent application Ser. No. 11/302,930 filed Dec. 14, 2005;
U.S. patent application Ser. No. 11/318,980 filed Dec. 27, 2005;
U.S. patent application Ser. No. 11/300,388 filed Dec. 14, 2005;
U.S. patent application Ser. No. ______ (Attorney Docket No. 16436US02) filed Jan. 17, 2006; and
U.S. patent application Ser. No. ______ (Attorney Docket No. 16437US02) filed Jan. 19, 2006.

Each of the above stated applications is hereby incorporated herein by reference in its entirety.

### FIELD OF THE INVENTION

Certain embodiments of the invention relate to mobile multimedia communications. More specifically, certain embodiments of the invention relate to a method and system for a mobile multimedia processor supporting rate adaptation and mode selection.

### BACKGROUND OF THE INVENTION

Mobile communications have changed the way people communicate and mobile phones have been transformed from a luxury item to an essential part of every day life. The use of mobile phones today is dictated by social situations, rather than hampered by location or technology. While voice connections fulfill the basic need to communicate, and mobile voice connections continue to filter even further into the fabric of every day life, various integrated mobile multimedia applications, utilizing the mobile Internet, may be the next step in the mobile communication revolution.

Third generation (3G) cellular networks offering various high speed access technologies and mobile telephones that have been specifically designed to utilize these technologies, fulfill demands for integrated multimedia applications supporting TV and audio applications utilizing advanced compression standards, high-resolution gaming applications, musical interfaces, peripheral interface support, etc. The processing requirements are being increased as chip designers take advantage of compression and higher bandwidths to transmit more information. 3G wireless applications support bit rates from 384 kilobits (Kbits)/second to 2 megabits (Mbits)/second, allowing chip designers to provide wireless systems with multimedia capabilities, superior quality, reduced interference, and a wider coverage area.

As mobile multimedia services grow in popularity and usage, factors such as power consumption, cost efficient optimization of network capacity and quality of service (QoS) will become even more essential to cellular operators than it is today. These factors may be achieved with careful network planning and operation, improvements in transmission methods, and advances in receiver techniques and chip integration solutions. To this end, carriers need technologies that will allow them to increase downlink throughput for the mobile multimedia applications support and, in turn, offer advanced QoS capabilities and speeds for consumers of mobile multimedia application services. Currently, mobile multimedia processors may not fully utilize system-on-a-chip (SOC) integration for advanced total system solution for today's mobile handsets. For example, conventional mobile processors may utilize a plurality of hardware accelerators to enable a variety of multimedia applications, which significantly increases power consumption, implementation complexity, mobile processor real estate, and ultimately terminal size.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for a mobile multimedia processor supporting rate adaptation and mode selection, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary mobile multimedia system, in accordance with an embodiment of the invention.

FIG. 1B is a block diagram of an exemplary mobile multimedia processor, in accordance with an embodiment of the invention.

FIG. 1C is a functional block diagram of an exemplary mobile multimedia processor with integrated peripherals that may be utilized in accordance with an embodiment of the invention.

FIG. 2 shows an exemplary system for host and peripheral interfaces in a mobile multimedia processor, in accordance with an embodiment of the invention.

FIG. 3a shows exemplary high speed signals, in accordance with an embodiment of the invention.

FIG. 3b shows exemplary low speed signals, in accordance with an embodiment of the invention.

FIG. 4 shows mobile multimedia processor circuitry supporting data latching and mode selection, in accordance with an embodiment of the invention.

FIG. 5 is a flow chart illustrating exemplary steps for mobile multimedia processor circuitry supporting data latching and mode selection, in accordance with an embodiment of the invention.

FIG. 6 is a flow chart illustrating exemplary steps for generating signals supporting data latching, in accordance with an embodiment of the invention.

### DETAILED DESCRIPTION OF THE INVENTION

Certain embodiments of the invention may be found in a method and system for a mobile multimedia processor supporting rate adaptation and mode selection. Various embodiments of the invention may provide a method and a system by which the mobile multimedia processor may receive input signals at a received clock rate, and communicate at least a portion of the received input signals to external circuitry at a lower clock rate. The mobile multimedia processor may latch a received input signal and subsequently generate a latched signal at the lower clock rate. The mobile multimedia processor may utilize a mode signal to select the received input signal or the latched signal. The selected signal may be communicated to the external circuitry. Thus, the mobile multimedia processor may communicate signals to external circuitry at a received clock rate, or at a lower clock rate.

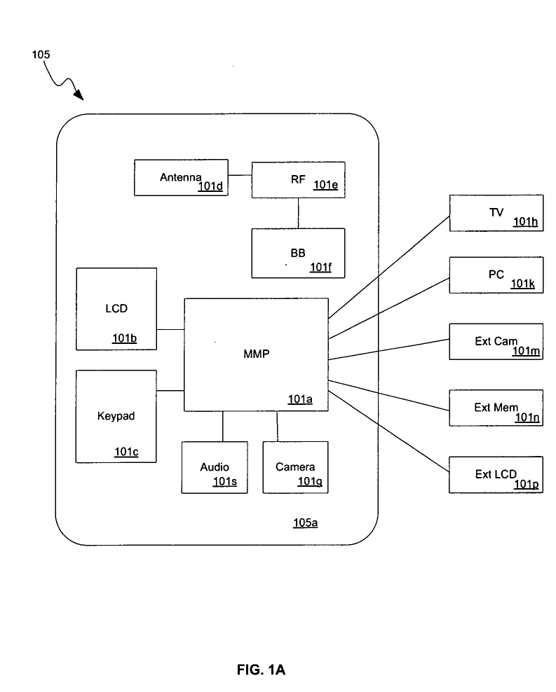

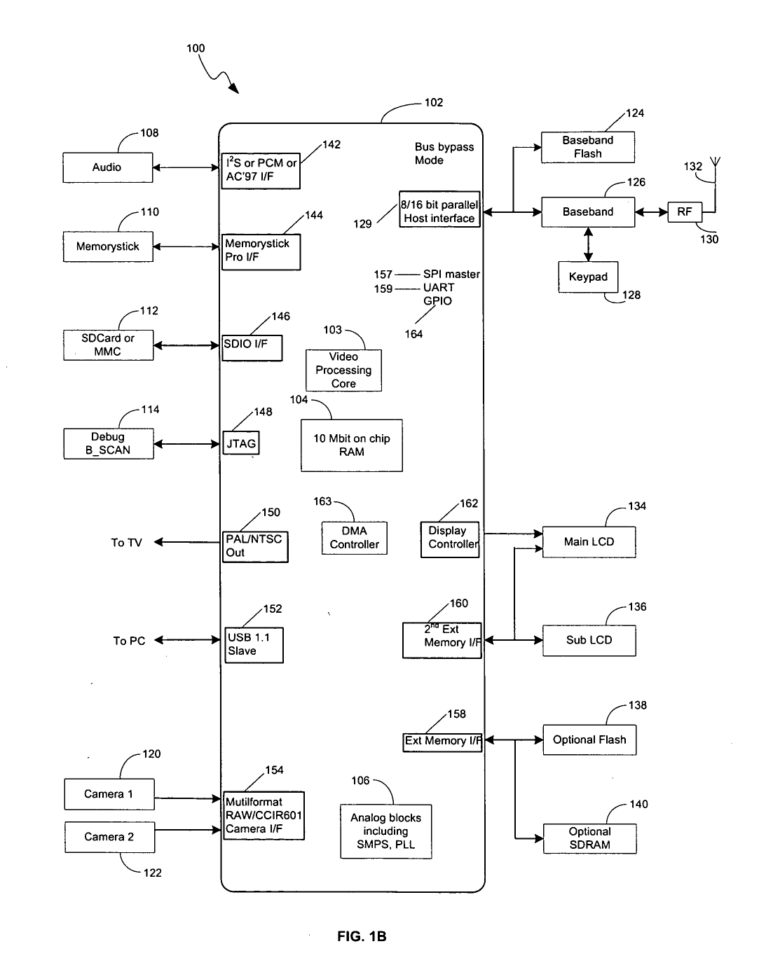

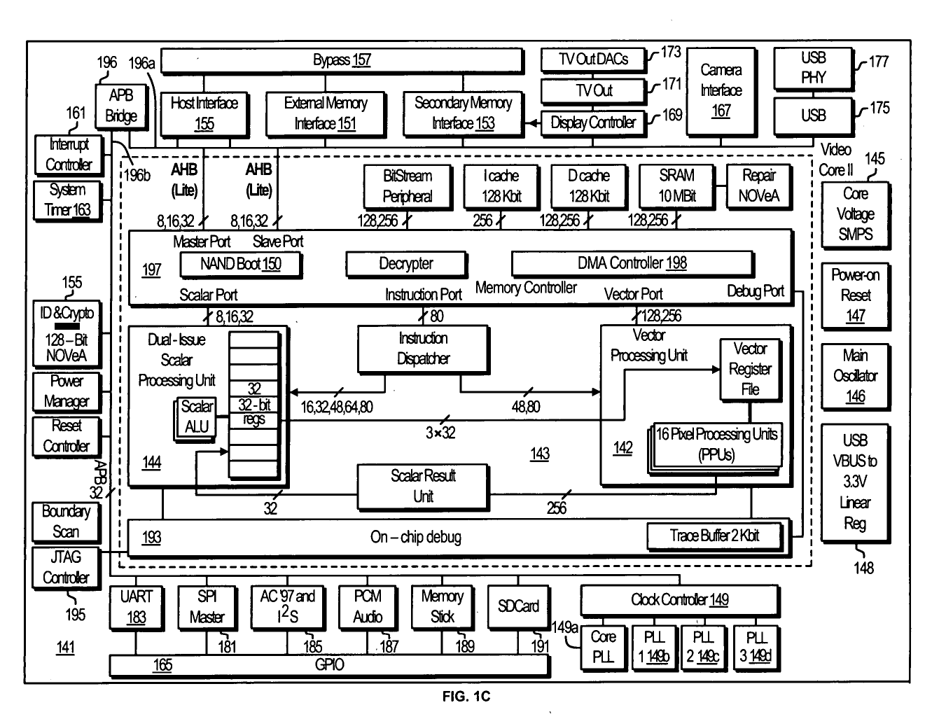

FIG. 1A is a block diagram of an exemplary mobile multimedia system, in accordance with an embodiment of the invention. Referring to FIG. 1A, there is shown a mobile multimedia system 105 that comprises a mobile multimedia device 105a, a TV 101h, a PC 101k, an external camera 101m, external memory 101n, and external LCD display 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, an LCD display 101b, a keypad 101c, and a camera 101g.

The MMP 101a may comprise suitable circuitry, logic, and/or code and may be adapted to perform video and/or multimedia processing for the mobile multimedia device 105a. The MMP 101a may further comprise a plurality of integrated interfaces, which may be utilized to support one or more external devices coupled to the mobile multimedia device 105a. For example, the MMP 101a may support connections to a TV 101h, a PC 101k, an external camera 101m, external memory 101n, and an external LCD display 101p.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video signals may also be received via the integrated camera 101g, the TV 101h, the PC 101k, and/or the external camera 101m. During processing, the MMP 101a may utilize the external memory 101n for storing of processed data. Processed audio data may be communicated to the audio block 101s and processed video data may be communicated to the LCD 101b or the external LCD 101p, for example. The keypad 101c may be utilized for communicating processing commands and/or other data, which may be required for audio or video data processing by the MMP 101a.

FIG. 1B is a block diagram of an exemplary mobile multimedia processor, in accordance with an embodiment of the invention. Referring to FIG. 1B, the mobile multimedia processor 102 may comprise suitable logic, circuitry and/or code that may be adapted to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise a video processing core 103, RAM 104, an analog block 106, a direct memory access (DMA) controller 163, an audio interface (I/F) 142, a memory stick I/F 144, SD card I/F 146, JTAG I/F 148, TV output I/F 150, USB I/F 152, a camera I/F 154, and a host I/F 129. The mobile multimedia processor 102 may further comprise a serial peripheral interface (SPI) 157, a universal asynchronous receiver/transmitter (UART) I/F 159, general purpose input/output (GPIO) pins 164, a display controller 162, an external memory I/F 158, and a second external memory I/F 160.

The video processing core 103 may comprise suitable circuitry, logic, and/or code and may be adapted to perform video processing of data. The RAM 104 may comprise suitable logic, circuitry and/or code that may be adapted to store on-chip data such as video data. In an exemplary embodiment of the invention, the RAM 104 may be adapted to store 10 Mbits of on-chip data, for example. The size of the on-chip RAM 104 may vary depending on cost or other factors such as chip size.

The analog block 106 may comprise a switch mode power supply (SMPS) block and a phase locked loop (PLL) block. In addition, the analog block 106 may comprise an on-chip SMPS controller, which may be adapted to generate its core voltage. The core voltage may be software programmable according to, for example, speed demands on the mobile multimedia processor 102, allowing further control of power management.

In an exemplary embodiment of the invention, the normal core operating range may be about 0.8 V-1.2 V and may be reduced to about 0.6 V during hibernate mode. The analog block 106 may also comprise a plurality of PLL's that may be adapted to generate about 195 kHz-200 MHz clocks, for example, for external devices. Other voltages and clock speeds may be utilized depending on the type of application. The mobile multimedia processor 102 may comprise a plurality of power modes of operation, for example, run, sleep, hibernate and power down. In accordance with an embodiment of the invention, the mobile multimedia processor 102 may comprise a bypass mode that may allow a host to access memory mapped peripherals in power down mode, for example. In bypass mode, the mobile multimedia processor 102 may be adapted to directly control the display during normal operation while giving a host the ability to maintain the display during standby mode.

The audio block 108 may comprise suitable logic, circuitry and/or code that may be adapted to communicate with the mobile multimedia processor 102 via an inter-IC sound (I²S), pulse code modulation (PCM) or audio codec (AC'97) interface 142 or other suitable interface, for example. In the case of an AC'97 and/or an I²S interface, suitable audio controller, processor and/or circuitry may be adapted to provide AC'97 and/or I²S audio output respectively, in either master or slave mode. In the case of the PCM interface, a suitable audio controller, processor and/or circuitry may be adapted to allow input and output of telephony or high quality stereo audio. The PCM audio controller, processor and/or circuitry may comprise independent transmit and receive first in first out (FIFO) buffers and may use DMA to further reduce processor overhead. The audio block 108 may also comprise an audio in, audio out port and a speaker/microphone port (not illustrated in FIG. 1B).

The mobile multimedia device 100 may comprise at least one portable memory input/output (I/O) block. In this regard, the memorystick block 110 may comprise suitable logic, circuitry and/or code that may be adapted to communicate with the mobile multimedia processor 102 via a memorystick pro interface 144, for example. The SD card block 112 may comprise suitable logic, circuitry and/or code that may be adapted to communicate with the mobile multimedia processor 102 via a SD input/output (I/O) interface 146, for example. A multimedia card (MMC) may also be utilized to communicate with the mobile multimedia processor 102 via the SD input/output (I/O) interface 146, for example. The mobile multimedia device 100 may comprise other portable memory I/O blocks such an xD I/O card.

The debug block 114 may comprise suitable logic, circuitry and/or code that may be adapted to communicate with the mobile multimedia processor 102 via a joint test action group (JTAG) interface 148, for example. The debug block 114 may be adapted to access the address space of the mobile multimedia processor 102 and may be adapted to perform boundary scan via an emulation interface. Other test access ports (TAPs) may be utilized. The phase alternate line (PAL)/national television standards committee (NTSC) TV output I/F 150 may be utilized for communication with a TV, and the universal serial bus (USB) 1.1, or other variant thereof, slave port I/F 152 may be utilized for communications with a PC, for example. The cameras 120 and/or 122 may comprise suitable logic, circuitry and/or code that may be adapted to communicate with the mobile multimedia processor 102 via a multiformat raw CCIR 601 camera interface 154, for example. The camera I/F 154 may utilize windowing and sub-sampling functions, for example, to connect the mobile multimedia processor 102 to a mobile TV front end.

The mobile multimedia processor 102 may also comprise a plurality of serial interfaces, such as the USB I/F 152, a serial peripheral interface (SPI) 157, and a universal asynchronous receiver/transmitter (UART) I/F 159 for Bluetooth or IrDA. The SPI master interface 157 may comprise suitable circuitry, logic, and/or code and may be utilized to control image sensors. Two chip selects may be provided, for example, to work in a polled mode with interrupts or via a DMA controller 163. Furthermore, the mobile multimedia processor 102 may comprise a plurality of general purpose I/O (GPIO) pins 164, which may be utilized for user defined I/O or to connect to the internal peripherals. The display controller 162 may comprise suitable circuitry, logic, and/or code and may be adapted to support multiple displays with XGA resolution, for example, and to handle 8/9/16/18/21-bit video data.

The baseband flash memory 124 may be adapted to receive data from the mobile multimedia processor 102 via an 8/16 bit parallel host interface 129, for example. The host interface 129 may be adapted to provide two channels with independent address and data registers through which a host processor may read and/or write directly to the memory space of the mobile multimedia processor 102. The baseband processing block 126 may comprise suitable logic, circuitry and/or code that may be adapted to convert RF signals to baseband and communicate the baseband processed signals to the mobile multimedia processor 102 via the host interface 129, for example. The RF processing block 130 may comprise suitable logic, circuitry and/or code that may be adapted to receive signals via the antenna 132 and to communicate RF signals to the baseband processing block 126. The host interface 129 may comprise a dual software channel with a power efficient bypass mode.

The main LCD 134 may be adapted to receive data from the mobile multimedia processor 102 via a display controller 162 and/or from a second external memory interface 160, for example. The display controller 162 may comprise suitable logic, circuitry and/or code and may be adapted to drive an internal TV out function or be connected to a range of LCD's. The display controller 162 may be adapted to support a range of screen buffer formats and may utilize direct memory access (DMA) to access the buffer directly and increase video processing efficiency of the video processing core 103. Both NTSC and PAL raster formats may be generated by the display controller 162 for driving the TV out. Other formats, for example SECAM, may also be supported

In one embodiment of the invention, the display controller 162 may be adapted to support a plurality of displays, such as an interlaced display, for example a TV, and/or a non-interlaced display, such as an LCD. The display controller 162 may also recognize and communicate a display type to the DMA controller 163. In this regard, the DMA controller 163 may be fetch video data in an interlaced or non-interlaced fashion for communication to an interlaced or non-interlaced display coupled to the mobile multimedia processor 102 via the display controller 162.

The substitute LCD 136 may comprise suitable logic, circuitry and/or code that may be adapted to communicate with the mobile multimedia processor 102 via a second external memory interface, for example. The mobile multimedia processor 102 may comprise a RGB external data bus. The mobile multimedia processor 102 may be adapted to scale image output with pixel level interpolation and a configurable refresh rate.

The optional flash memory 138 may comprise suitable logic, circuitry and/or code that may be adapted to communicate with the mobile multimedia processor 102 via an external memory interface 158, for example. The optional SDRAM 140 may comprise suitable logic, circuitry and/or code that may be adapted to receive data from the mobile multimedia processor 102 via the external memory interface 158, for example. The external memory I/F 158 may be utilized by the mobile multimedia processor 102 to connect to external SDRAM 140, SRAM, Flash memory 138, and/or external peripherals, for example. Control and timing information for the SDRAM 140 and other asynchronous devices may be configurable by the mobile multimedia processor 102.

The mobile multimedia processor 102 may further comprise a secondary memory interface 160 to connect to connect to memory-mapped LCD and external peripherals, for example. The secondary memory interface 160 may comprise suitable circuitry, logic, and/or code and may be utilized to connect the mobile multimedia processor 102 to slower devices without compromising the speed of external memory access. The secondary memory interface 160 may provide 16 data lines, for example, 6 chip select/address lines, and programmable bus timing for setup, access and hold times, for example. The mobile multimedia processor 102 may be adapted to provide support for NAND/NOR Flash including NAND boot and high speed direct memory access (DMA), for example.

In operation, the mobile multimedia processor 102 may be adapted to support multiple display formats for displaying processed video data. For example, interlaced and/or non-interlaced external displays may be connected to the mobile multimedia processor 102 via the display controller 162. The display controller 162 may communicate the external display type to the DMA controller 163. The DMA controller 163 may then access the on-chip RAM 104 and may fetch processed video data in an interlaced or non-interlaced format, corresponding to the external display type.

FIG. 1C is a functional block diagram of an exemplary mobile multimedia processor with integrated peripherals that may be utilized in accordance with an embodiment of the invention. Referring to FIG. 1C, the mobile multimedia processor 141 may comprise a processor core 143, a core voltage switch mode power supply (SMPS) 145, a USB linear regulator 148, a main oscillator 146, a reset controller 147, a clock controller 149, phase locked loop (PLL) modules 149a, . . . , 149d, an external memory interface 151, a secondary memory interface 153, a host interface 155, bypass logic 157, ID and cryptography module 159, and interrupt controller 161. The mobile multimedia processor 141 may further comprise a system timer 163, general purpose I/O (GPIO) module 165, camera interface 167, display controller 169, TV output interface 171, TV output converter 173, USB interface 175, USB physical (PHY) layer interface 177, serial peripheral interface (SPI) 181, and universal asynchronous receiver/transmitter (UART) interface 183. The mobile multimedia processor 141 may also comprise Audio Codec '97 (AC'97) and inter-IC sound (I²S) controller 185, pulse code modulation (PCM) audio interface 187, memory stick interface 189, SD card interface 191, Joint Test Action Group (JTAG) controller 195, peripheral bus 196, advanced high-performance bus (AHB) 196a, and advanced peripheral bus (APB) 196b. The processor core 143 may comprise a memory controller 197, on-chip debug module 193, a vector processing unit 142, and a scalar processing unit 144. The memory controller 197 may comprise a NAND boot module 150 and a direct memory access (DMA) controller 198.

The processor core 143 may be adapted to process applications built on 2-D representations of data, such as image processing. Image-processing tasks within the processing core 143 may be partitioned across the scalar processing unit 144 and/or the vector processing unit 142, which may allow the processor core 143 to operate at clock speeds of up to 150 MHz. The scalar processing unit 144 may be adapted to execute two scalar instructions per cycle. Branch prediction logic may also be utilized to minimize pipeline stalls. Furthermore, the processor core 143 may utilize a backward-compatible instruction set, as well as new instructions allowing for 32-bit audio support.

The core voltage SMPS 145 may comprise suitable circuitry, logic, and/or code and may be utilized to generate voltage for the processor core 143 within the mobile multimedia processor 141. The voltage may be software programmable according to speed demands of the chip, allowing further control of power management. The core operating range may be from about 0.8V to 1.2V, for example, and may be reduced to 0.6V in HIBERNATE mode. The processor core 143 may be adapted to control the output voltage of the on-chip power supply 145, thus reducing power consumption when the mobile multimedia processor 141 is not running at maximum speed. The core voltage supplied by the SMPS 145 may be independently set for when the processor core 143 is running (or asleep), and when hibernating. In RUN mode, for example, the core voltage may be adjusted between 0.8V and 1.2V to meet performance/power-saving requirements. In HIBERNATE mode, the core voltage may be reduced to 0.6V, for example, to minimize power consumption without losing state. Both voltages may be initialized to 1.2V on power-up and after a reset. If the core voltage is changed, a “watchdog” module may be utilized to recover from failure and clock speed within the mobile multimedia processor 141 may be reduced so that the processor core 143 may cope with the lower voltage.

The USB linear regulator 148 may comprise suitable circuitry and/or logic and may be adapted to generate supply voltage, such as 3.3V, for the USB PHY layer interface 177 from the 5V USB VBUS supply.

The reset controller 147 may comprise a boot controller and/or a power-on-reset cell. Following reset, the boot controller may examine the pin configuration within the mobile multimedia processor 141 to determine a required mode and may control the internal memory BIST/BISR and external Flash boot as may be required.

The clock controller 149 may comprise suitable circuitry and/or logic and may be adapted to coordinate four PLL modules 149a, . . . , 149d and to generate clocks for the processor core 143 and/or for the peripherals. The clock controller 149 may utilize the PLL modules 149a, . . . , 149d and/or additional independent divider circuits to allow a wide range of clocks to be generated, allowing the peripherals within the mobile multimedia processor 141 to be driven by an appropriate frequency while only requiring a single external crystal, or clock source. The core clock may be driven from the main oscillator 146 (normally 13.5 MHz, for example) on power-up and may subsequently be switched to the core PLL 149a after the core PLL 149a has been enabled.

The core PLL 149a may comprise suitable circuitry, logic, and/or code and may be utilized to adjust the core clock frequency to meet performance and/or power consumption requirements. In addition to the core PLL 149a, the remaining PLL modules 149b, 149c, and 149d s may be utilized to allow a wide range of independent clock frequencies to be generated for use by the various peripherals. Further, the clock controller 149 may supply independent clocks for the frequency-critical peripherals, such as camera, LCD, automatic customer/caller identification system (ACIS), PCM, universal serial bus (USB), and/or removable memory devices. The clock manager 149 may also supply a general-purpose clock (GENCLK) that may be supplied to the output on the GPIO interface 165. Each clock may be derived from the main oscillator 146 and/or from one of the three PLL modules 149b, 149c, 149d. The core PLL 149a may also be selected as the clock source.

The main oscillator 146 may be adapted to support crystal frequencies up to 27 MHz, for example. The internal PLL modules 149a, . . . , 149d may be utilized to produce the desired core clock frequency. The oscillator 146 may also be driven with a digital clock signal. When using an external clock source within the mobile multimedia processor 141, input frequencies up to 35 MHz may be supported.

The external memory interface 151 may comprise suitable circuitry and/or logic and may allow connection of 16-bit or 32-bit SDRAM, and/or asynchronous memory devices, to the mobile multimedia processor 141. Control and timing information for both the SDRAM and the asynchronous memories may be fully configurable by the processor core 143. External direct memory access (DMA) may be also supported via the DMA controller 198.

The NAND boot module 150 may comprise suitable circuitry and/or logic and may be designed to load a boot program into internal SRAM and then wake up the processor from sleep. The boot code may be stored in consecutive pages of NAND flash memory, with the first page being on a 16 kbyte address boundary within the first 128 kbytes, for example. The first 16-bits of the boot code may comprise a signature word, for example. The next 16-bits may comprise the size of the boot executable in 32-bit words, followed by the boot executable itself. To protect against data corruption in the boot code, each word of the boot code may be repeated.

The secondary memory interface 153 may comprise suitable circuitry and/or logic and may allow slower devices to be connected without compromising the speed of external memory access. The secondary memory interface 153 may comprise 16 data lines and six chip select/address lines. In addition, the secondary memory interface 153 may comprise programmable bus timing for setup, access, and/or hold times. Alternatively, these pins may be used to connect to an LCD, for example.

The host interface 155 may comprise suitable circuitry and/or logic and may provide two channels with independent address and data registers through which a host processor may read or write directly to the address space of the mobile multimedia processor 141. FlFOs and an auto-incrementing address mode may be utilized for efficient transfer of large blocks of data. The host interface 155 allows the mobile multimedia processor 141 to be used as a coprocessor to a main system processor, for example. The host interface 155 may be connected to the host processor's main bus.

The bypass logic 157 may be utilized by the host processor to access the external and secondary memory interfaces, for example, while the processor core 143 is powered down. In this regard, the mobile multimedia processor 141 may directly control the display during normal operation while still giving the host the ability to maintain the display during system standby. As there is no clock to the mobile multimedia processor 141 in this mode, all timing may be driven from the host bus signals.

The ID and cryptography module 159 may comprise suitable circuitry and/or logic and may be utilized to support digital rights management and to allow the mobile multimedia processor 141 to securely execute encrypted code.

The interrupt controller 161 may comprise suitable circuitry and/or logic and may be adapted to support 32 hardware interrupt sources, for example. Each source may be assigned to one of seven priority levels, for example, or may be masked. The interrupt controller 161 may generate a global interrupt signal and/or a 5-bit vector identifying the specific interrupt number. Dedicated DMA-based peripherals, such as the display controller 169 and camera interface 167, may rely on the DMA controller 198 to generate an interrupt, if processor action is required. Other peripherals, such as the UART 183, SPI 181, removable memory device, and/or AC'97/I2S controller 185 may generate their own interrupts, which may feed directly into the interrupt controller 161.

The system timer peripheral 163 may provide four timer channels running off a single free running counter. Each channel may comprise an output compare register that may be used to generate an interrupt.

The GPIO module 165 may comprise a plurality of general-purpose I/O pins. The pins may be used either for user defined I/O, or to connect to the internal peripherals. The GPIO pins may be split across two banks, which may be operated at different supply voltages. Most of the peripheral functions may be replicated in both banks for flexibility. When operating as GPIO, each pin may be configured as input, output or bi-directional, may comprise a configurable pull-up or pull-down resistor, and may be adapted to generate an edge or level triggered interrupt.

The camera interface 167 may be connected to two cameras, for example, one for still images and one for video, or one front and one back. The camera I/F 167 may be adapted to support CCIR 601 (YUV 4:2:0) video source and raw image sensor AFE chip inputs, with images sizes up to eight megapixels. The camera I/F 167 may also support windowing and sub-sampling in YUV and/or in raw modes.

The display controller 169 may comprise suitable circuitry and/or logic and may be connected to a range of TFT LCDs or may be used to drive the internal TV Out function. The display controller 169 may support a range of screen buffer formats, and may utilize DMA to access the buffer directly, removing any processor overhead. Screen buffer sizes may be any size up to XGA, and the display controller 169 may be adapted to automatically scale this up or down onto an output raster that may be any size up to SXGA. Both NTSC and PAL raster formats may be generated by the display controller 169 for driving the TV Out functionality. The pins for the secondary memory interface may instead be used to connect a direct drive LCD. Fully programmable strobe and porch timing, as well as 7 bits/pixel color scheme, may be supported by the display controller 169. The display controller 169 may be adapted to read data from a screen buffer via DMA, and may produce pixel and synchronization signals that may be utilized to drive the internal TV Out block, or an external LCD. The display controller 169 may also be adapted to scale the output data on the fly, allowing the size of the screen buffer to reflect the picture resolution rather than the desired screen size.

In an exemplary aspect of the invention, the display controller 169 may be adapted to generate control signal for an on-chip DMA controller 198 and may instruct the DMA controller 198 to acquire interlaced and/or non-interlaced decoded video data in accordance with the type of display device that may be connected to the mobile multimedia processor 141. The TV output interface 171 and the TV output converter 173 may utilize standard NTSC or PAL raster acquired from the display controller 169 and may be adapted to generate either a composite video or S-video output to feed into a TV, for example. The USB interface 175 may support USB slave connection. The USB PHY layer interface 177 may be utilized to reduce USB system size, cost and power consumption.

The SPI peripheral 181 may be utilized by image sensors or other peripherals. Two chip selects may be provided, and the interface may be adapted to work in polled mode, with interrupts, or via the DMA controller 198. The UART 183 may comprise a standard 16550 UART, supporting baud rates up to about 921,600. The AC'97 and I²S controller 185 may be adapted to provide AC'97 and/or I²S audio output in either master or slave mode. AC'97 audio input may also be supported. The controller 185 may comprise independent transmit and/or receive FIFOs, and may utilized the DMA controller 198 to further reduce processor overhead. Accurate bit clocks may be generated by one of the on-chip PLLs without compromising the frequency requirements of the clocks for the core or other peripherals.

The PCM audio interface 187 may comprise suitable circuitry, logic, and/or code and may allow input and/or output of telephony or high quality stereo audio, as well as the classic PCM and I²S formatted-output signals. The interface 187 may comprise independent transmit and/or receive FIFOs, and may utilize DMA to further reduce processor overhead. The memory stick interface 189 may comprise a Sony Memory Stick Pro™ Host, allowing seamless connection to Memory Stick and Memory Stick Pro devices. The SD Card interface 191 may allow connection to SD, xD Card or variants thereof, and/or MMC devices. Both 1-bit and 4-bit transfers may be supported by the interface 191, and DMA may be used to move the data to or from on-chip memory.

The on-chip debug module 193 may be accessed via the JTAG controller 195. The debug module 193 may provide access to all of the address space of the mobile multimedia processor 141 and control of the processor core 143, as well as additional features, such as breakpoints and code profiling. The embedded JTAG controller 195 may utilize direct access to the scalar processing unit 144, the vector processing unit 142 and/or the memory controller 197, allowing it to snoop on major buses within the processor core 143. Such tight integration may provide memory and register access, control over program execution, run to breakpoint, setting of break conditions, single stepping and/or code profiling. A built-in program and data trace buffer may allow examination of program state after a breakpoint or exception.

The peripheral bus 196 may comprise the AMBA™ (Advanced Microcontroller Bus Architecture) to connect the peripheral control/status registers to the memory controller 197. The external memory interface 151, camera interface 167, bitstream peripherals, host interfaces, USB device controller 175, and display controller 169 may be attached to the Advanced High-performance Bus (AHB) 196a. The AHB 196a may pass through a simple bridge to the lower-speed Advanced Peripheral Bus (APB) 196b through which the rest of the peripheral control/status registers may be accessed.

The memory controller 197 may comprise suitable circuitry, logic, and/or code and may be utilized for servicing all memory requests within the mobile multimedia processor 141. The memory controller 197 may be adapted to perform address decoding, may arbitrate between the different bus masters, may maintain data cache coherence, and may handle DMA transfers. The DMA controller 198 may be utilized to transfer data between peripherals and memory, independently of the vector processing unit 142 and the scalar processing unit 144. The DMA controller 198 may comprise dedicated wide and narrow data ports to the memory controller 197, and may seamlessly interface sources and destinations of different widths. The DMA controller 198 may comprise 16 sub-channels that may be grouped into a plurality of channels. Each channel may be associated with one of a plurality of system peripherals. The DMA controller 198 may be adapted to support 2-dimensional DMA, allowing windowed images or non-consecutive data items to be transferred. In this regard, the DMA controller 198 may be adapted to fetch non-consecutive processed video data from memory for display by one or more external displays communicatively coupled to the mobile multimedia processor 141. For example, the DMA controller 198 may be adapted to fetch interlaced or non-interlaced video data for display on an interlaced or non-interlaced display. Furthermore, the DMA controller 198 may be adapted to skip one or more video lines between fetched video lines so that scaling or other video processing may be achieved without redundant use of stored video data.

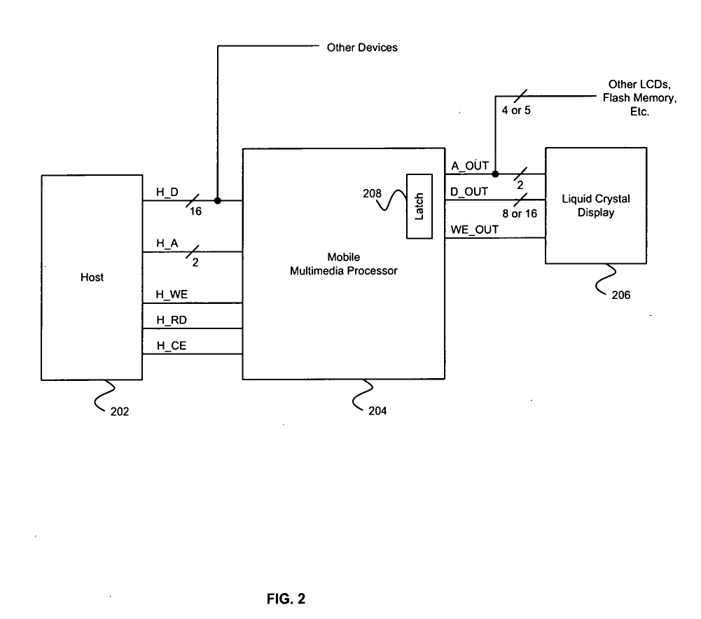

FIG. 2 shows an exemplary system for host and peripheral interfaces in a mobile multimedia processor, in accordance with an embodiment of the invention. With reference to FIG. 2 there is shown a host 202, mobile multimedia processor 204, liquid crystal display 206, and a latch 208. The host interface between the host 202 and the mobile multimedia processor 204 may comprise a host data signal, h_d, a host address signal, h_a, a host write enable signal, h_we, a host read signal h_rd, and a host chip enable signal h_ce. The peripheral interface between the liquid crystal display (LCD) 206 and the mobile multimedia processor 204 may comprise a data out signal, d_out, an address out signal, a_out, and a write enable out signal, we_out.

The h_ce signal may be communicated by the host 202 to the mobile multimedia processor 204. The h_d signal may comprise a plurality of bits of binary information, for example 16 bits, which may be communicated between the host 202 and the mobile multimedia processor 204. The h_d signal may also be communicated to other devices. The h_a signal may comprise a plurality of binary address bits, for example 2 bits, which may be communicated between the host 202 and the mobile multimedia processor 204. The h_we signal may comprise a write enable signal that may be communicated between the host 202 and the mobile multimedia processor 204.

The a_out signal may comprise a plurality of binary address bits, for example 6 bits, which may be communicated between the mobile multimedia processor 204 and the LCD 206. A plurality of bits from the a_out signal, for example at least 4 bits, may be communicated to other devices such as, for example, LCDs and flash memory. The d_out signal may comprise a plurality of bits of binary information, for example 8 bits or 16 bits, that may be communicated between the mobile multimedia processor 204 and the LCD 206. The we_out signal may comprise a write enable signal that may be communicated between the mobile multimedia processor 204 and the LCD 206. The signals a_out, d_out, and we_out may be communicated to the LCD 206 by the mobile multimedia processor 204 via a latch 208.

In operation, the h_ce signal may enable the mobile multimedia processor 204 to respond to other signals received from the host 202, for example, the signals h_rd, h_a, and/or h_d. The host 202 may receive data by communicating to the mobile multimedia processor 204 via the h_rd signal. The data may be specified based on the address signal h_a, which may also be communicated by the host 202 to the mobile multimedia processor 204. The mobile multimedia processor 204 may respond to the h_rd signal and address signal h_a by communicating the specified data to the host 202 via the signal h_d.

The host 202 may also communicate data, via the signal h_d, to the mobile multimedia processor 204, which is to be written to a location based on the address signal h_a, which may also be communicated by the host 202 to the mobile multimedia processor 204. The host 202 may also communicate to the mobile multimedia processor 204, via the signal h_we, which enables the mobile multimedia processor 204 to store the data, communicated in the signal h_d, at a location based on the address signal h_a.

The mobile multimedia processor may perform a series of processing steps on the data received via the signal h_d, and communicate a resultant output to the LCD 206. The output may be stored in a latch 208 and presented to the LCD 206. The output presented by the latch may comprise output data, which is communicated to the LCD 206 via the signal d_out, an output address, which is communicated to the LCD 206 via the signal a_out, and a write enable signal, which is communicated to the LCD 206 via the signal we_out. The we_out signal may enable the LCD 206 to store the data, communicated in the signal d_out, at a location based on the address signal a_out.

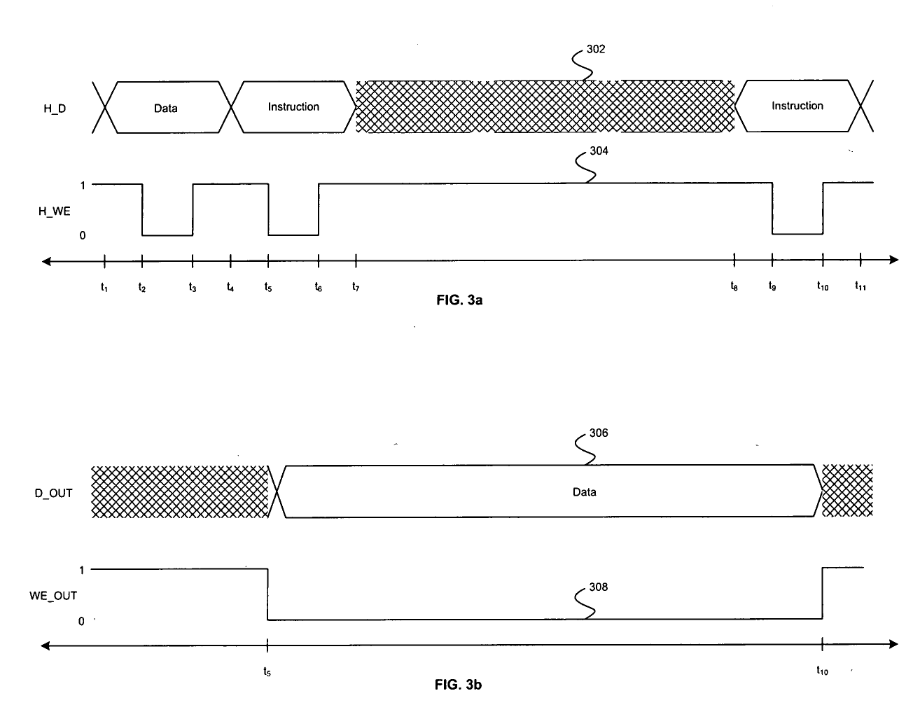

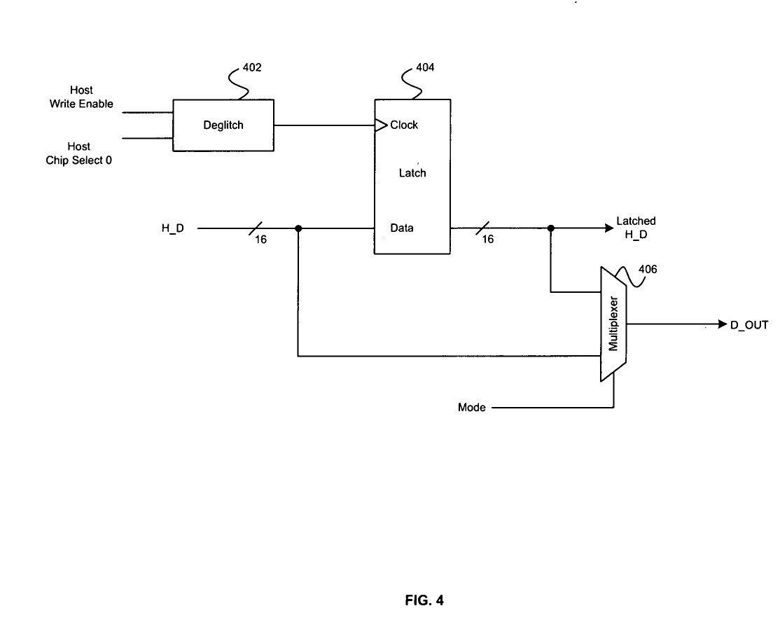

FIG. 3a shows exemplary high speed signals, in accordance with an embodiment of the invention. With reference to FIG. 3a, there is shown a data signal h_d 302, and a write enable signal h_we 304. The signal h_d 302 may represent data and/or instructions which may been communicated by the host 202 to the mobile multimedia processor 204. The data may be initially present in the data signal h_d 302 starting at a time instant t₁, for example. The host 202 may continue to present the data in the data signal h_d 302 until a subsequent time instant t₄, for example. Between the time instant t₄ and the time instant t₇ an instruction may be present in the data signal h_d 302. The instruction may cause the mobile multimedia processor 204 to perform an operation with the previously received data. For example, the instruction may cause the mobile multimedia processor 204 to communicate the previously received data utilizing an output signal. Between the time instant t₇ and the time instant t₈ other data and/or instructions may be present in the data signal h_d 302, for example. Between the time instant t₈ and the time instant t₁₁ a subsequent instruction may be present in the data signal h_d 302, for example. The subsequent instruction may, for example, cause the multimedia processor 204 to cease communication of the previously received data utilizing the output signal.

The write enable signal, h_we 304, may be communicated by the host 202 to the mobile multimedia processor 204. At the time instant t₁, the signal level of the write enable signal h_we 304 may comprise a signal level of 1, or logic level HIGH. At a subsequent time t₂, the signal level of the write enable signal h_we 304 may transition from a logic level HIGH to a signal level of 0, or logic level LOW. Between the time instant t₂ and a subsequent time instant t₃ the signal level of the write enable signal h_we 304 may be logic level LOW, for example. Between the time instant t₂ and the subsequent time instant t₃, the mobile multimedia processor 204 may be enabled to receive the data contained in the data signal h_d 302 from the host 202. At the subsequent time t₃, the signal level of the write enable signal h_we 304 may transition from a logic level LOW to a logic level HIGH. Between the time instant t₃ and a subsequent time instant t₅ the signal level of the write enable signal h_we 304 may be logic level HIGH, for example. At the subsequent time t₅, the signal level of the write enable signal h_we 304 may transition from a logic level HIGH to a logic level LOW. Between the time instant t₅ and a subsequent time instant t₆ the signal level of the write enable signal h_we 304 may be logic level LOW, for example.

Between the time instant t₅ and the subsequent time instant t₆, the mobile multimedia processor 204 may be enabled to receive the instruction contained in the data signal h_d 302 from the host 202. At the subsequent time t₆, the signal level of the write enable signal h_we 304 may transition from a logic level LOW to a logic level HIGH. Between the time instant t₇ and a subsequent time instant t₉ the signal level of the write enable signal h_we 304 may be logic level HIGH, for example. At the subsequent time t₉, the signal level of the write enable signal h_we 304 may transition from a logic level HIGH to a logic level LOW. Between the time instant t₉ and a subsequent time instant t₁₀ the signal level of the write enable signal h_we 304 may be logic level LOW, for example. Between the time instant t₉ and the subsequent time instant t₁₀, the mobile multimedia processor 204 may be enabled to receive the subsequent instruction contained in the data signal h_d 302 from the host 202. At the subsequent time t₁₀, the signal level of the write enable signal h_we 304 may transition from a logic level LOW to a logic level HIGH.

The mobile multimedia processor 204 may store the data d₁, contained within the data signal h_d 302, within a time interval comprising the time instant t₂ and the time instant t₃ during which the signal level of the write enable signal h_we 304 may be at a logic level LOW. When the mobile multimedia processor 204 has stored the data d₁ the data may be output.

FIG. 3b shows exemplary low speed signals, in accordance with an embodiment of the invention. With reference to FIG. 3b, there is shown a data signal d_out 306, and a write enable signal we_out 308. The data signal d_out 306 may represent data, which has been communicated by the mobile multimedia processor 204 to the LCD 206. The data contained in the data signal d_out 306 may represent a latched version of the data contained in the data signal h_d 302. The data may be initially present in the data signal d_out 306 starting at a time, instant t₅, for example. The mobile multimedia processor 204 may continue to present the data in the data signal d_out 306 until a subsequent time instant t₁₀, for example. The time instants t₅ and t₁₀ from FIG. 3b may correspond to the time instants t₅ and t₁₀ from FIG. 3a.

The write enable signal, we_out 308, may be communicated by the mobile multimedia processor 204 to the LCD 206. At a time instant prior to the time instant t₅, the signal level of the write enable signal we_out 308 may comprise a logic level HIGH. At about the time instant t₅, the signal level of the write enable signal we_out 308 may transition from a logic level HIGH to a logic level LOW. Between the time instant t₅ and the subsequent time instant t₁₀ the signal level of the write enable signal we_out 308 may be logic level LOW, for example. At about the subsequent time t₁₀, the signal level of the write enable signal we_out 308 may transition from a logic level LOW to a logic level HIGH.

In operation, the mobile multimedia processor 204 may communicate data, via the signal d_out 306, to the LCD 206 that is to be written to a location based on the address signal a_out, which may also be communicated by the mobile multimedia processor 204 to the LCD 206. The mobile multimedia processor 204 may also communicate to the LCD 206 the signal we_out, which enables the mobile multimedia processor 204 to store the data, communicated in the signal d_out, at a location based on the address signal a_out.

In various embodiments of the invention, the latch 208 within the mobile multimedia processor 204 may enable devices that operate at lower speeds, based on for example a clock rate, to receive data from devices that operate at higher speeds. For example, in FIG. 2, the host 202 may communicate data via the signals h_we, h_a, and/or h_d at a rate that is faster than the rate at which the LCD 206 may receive data via the corresponding signals we_out, a_out, and/or d_out. The host 202 may, for example, communicate data at a rate based on the signals h_d 302, and h_we 304. A length of a time interval, such as one beginning at about the time instant to and ending at about the time instant t₄, during which the host 202 may present the data in signal h_d, for example, may be referred to as a data hold time. The host 202 may communicate data at a rate, host_rate, based on a quantity B(data)/(host data_hold_time), where B(data) may represent a quantity about equal to the number of bits contained in the data, and the quantity host_data_hold_time may refer to a hold time utilized by the host 202.

The LCD 206 may not be able to receive information communicated at the host rate. For example, the LCD 206 may require a data hold time based on a length of a time interval, such as one beginning at about the time instant t₅ and ending at about the time instant t₁₀. A rate at which the LCD 206 may receive data, LCD_rate, may be based on a quantity B(data)/(LCD_data_hold_time) where B(data) may represent a quantity about equal to the number of bits contained in the data, and the quantity LCD_data_hold_time may refer to a hold time utilized by the LCD 206.

In various embodiments of the invention, the host 202 may communicate data to an LCD 206 via the mobile multimedia processor 204. The host 202 may communicate data to the mobile multimedia processor 204 via the signal h_d 302. The host 202 may utilize a data hold time corresponding to the host_data_hold_time. The latch 208 within the mobile multimedia processor 204 may store the data at about the time instant t₅, at which the signal h_we may transition from logic level HIGH to logic level LOW. In response, the signal we_out 308 may transition from logic level HIGH to logic level LOW, and the mobile multimedia processor 204 may communicate the data to the LCD 306 via the signal d_out 306. At the subsequent time instant t₆ the signal h_we 304 may transition from logic level LOW to logic level HIGH. The signal we_out 308 may be maintained at a logic level LOW. At one or more time instants subsequent to the time instant t₇ the host 202 may communicate with other peripheral devices or systems. Thus, the host 202 may communicate information to one or more peripheral devices or systems at the host_rate. At the subsequent time instant t₉ the signal h_we 304 may transition from logic level HIGH to logic level LOW. At the subsequent time instant t₁₀ the signal h_we 304 may transition from logic level LOW to logic level HIGH. In response, the signal we_out 308 may transition from logic level LOW to logic level HIGH at about the subsequent time instant t₁₀. The time interval during which the signal we_out 308 is maintained at a logic level LOW, for example, may correspond to an LCD data_hold_time.

In some conventional systems in which the host 202 communicates with the LCD 206, the long_host_data_hold_time may comprise a length of time interval, such as one beginning at the time instant t₄ and ending at the time instant t₁₀. The long_host_data_hold_time may comprise a longer time interval than may the host_data_hold_time. At the time instant t₅ the signal h_we 304 may transition from logic level HIGH to logic level LOW. At the subsequent time instant t₁₀ the signal h_we 304 may transition from logic level LOW to logic level HIGH. In such conventional approaches, the host 202 may communicate information with one or more peripheral devices at a slow_host_rate where the slow_host_rate may represent a lower operating speed than may be represented by the host_rate.

FIG. 4 shows mobile multimedia processor circuitry supporting data latching and mode selection, in accordance with an embodiment of the invention. With reference to FIG. 4, there is shown a deglitch block 402, a latch 404, and a multiplexer 406. The deglitch block 402 may delay application of the host write enable signal, received from the host 202 (FIG. 2), in the mobile multimedia processor 204. U.S. patent application Ser. No. ______ (Attorney Docket No. 16430US02) filed Jan. 19, 2006 provides a detailed description of the deglitch block, and is hereby incorporated herein in its entirety. The latch 404 may acquire a signal level presented at the data input at an instant in time at which the signal level presented at the clock input transitions from low to high. The latch 406 may generate an output signal from the acquired signal level wherein the level is maintained at the output until at least an instant in time at which the signal level presented at the clock input transitions from high to low. The multiplexer 406 may utilize either of the input signals to generate an output based on the mode input.

In operation, the host write enable, and the host chip select signals from the host 202 may be processed by the deglitch block 402 in the mobile multimedia processor 204. The output of the deglitch block 402 may be communicated to the clock input of the latch 404. The latch may capture the binary signal levels for each of a plurality of bits in the signal h_d that may comprise a plurality of bits from data communicated by the host 202 to the mobile multimedia processor 204. The binary signals levels from the signal h_d that are captured by the latch 404 may be utilized to generate an output signal latched h_d. The signals h_d and latched h_d may be input to the multiplexer 406. The multiplexer 406 may generate an output signal d_out from among the signals h_d and latched h_d based on the mode signal. The mode signal may be generated internally by the mobile multimedia processor 204 based on the whether the signal d_out is to be a high speed signal or a low speed signal. If the signal d_out is to be a high speed signal, the mode input may enable the multiplexer 406 to generate the signal d_out based on the signal h_d. If the signal d_out is to be a low speed signal, the mode input may enable the multiplexer 406 to generate the signal d_out based on the signal latched h_d.

In various embodiments of the invention, a mobile multimedia processor 204 may receive signals from an input source. The input source may be an integrated circuit device, for example. The input source may also be referred to as a host 202, for example. The received signals may comprise host data, host address, and host write enable signals. The received signals may be presented to the mobile multimedia processor 204 at a host clock rate according to a host write enable signal. The mobile multimedia processor 204 may latch a current binary value of a host data signal, or a host address signal, based on a current binary value of the host write enable signal. For example, the current binary values of the host address, and host data signals may be latched by the mobile multimedia processor 204 at an instant in time when the host write enable signal asserts a logic level LOW input signal.

The mobile multimedia processor 204 may generate latched signals based on the received signals. These latched signals may be communicated to circuitry. The circuitry may be an integrated circuit device, for example. The latched signals may comprise latched data, latched address, and latched write enable signals. The latched signals may be generated by the host multimedia processor 204 at a latched clock rate according to a latched write enable signal. For example, the current binary values of the latched address, and latched data signals may be communicated to the external circuitry at an instant in time when the latched write enable signal is asserted to a logic level LOW output signal. The mobile multimedia processor 204 may convert a host clock rate to a latched clock rate. The host clock rate may comprise a higher clock rate than the latched clock rate.

The current binary value of the latched address signal may be generated based on the current binary value of the host address signal. The current binary value of the latched address signal may be maintained for a time duration corresponding to the current binary value of the latched write enable signal. For example, the current binary value of the host address signal may be maintained by the mobile multimedia processor 204 for a time duration corresponding to a time duration in which the current binary value of the latched write enable signal is asserted to a logic level LOW output signal.

The mobile multimedia processor 204 may detect a change in the current binary value of the host write enable signal at a current instant in time. For example, the mobile multimedia processor 204 may detect a change in the binary value of the host write enable signal from logic level HIGH to logic level LOW. The mobile multimedia processor 204 may generate a change in a corresponding binary value of the latched write enable signal according to the detected change in the current binary value of the host write enable signal. For example, in response to a detected change in the binary value of the host write enable signal from logic level HIGH to logic level LOW, a corresponding change may be generated in the current binary value of the latched write enable signal from logic level HIGH to logic level LOW.

Following a change in the binary value of the latched write enable signal, the subsequent binary value may be maintained for a time duration according to the latched clock rate. The binary value of the latched write enable signal may change at a rate that corresponds to the latched clock rate. The mobile multimedia processor 204 may subsequently change the binary value of the latched write enable signal at the end of the time duration. For example, at an instant in time, the binary value of the latched write enable signal may change from logic level HIGH to logic level LOW. This binary value may be maintained for a subsequent time duration. The length of the time duration may correspond to a period associated with the latched clock rate. At a time instant following the subsequent time duration, the binary value of the latched write enable signal may change again from logic level LOW to logic level HIGH in response to a subsequent change in the host write enable signal.

The mobile multimedia processor 204 may make a selection, from among a group comprising the host address signal and the latched address signal, based on a mode signal. The selected signal may be communicated to the circuitry. Corresponding data signals and write enable signals may also be communicated to the circuitry.

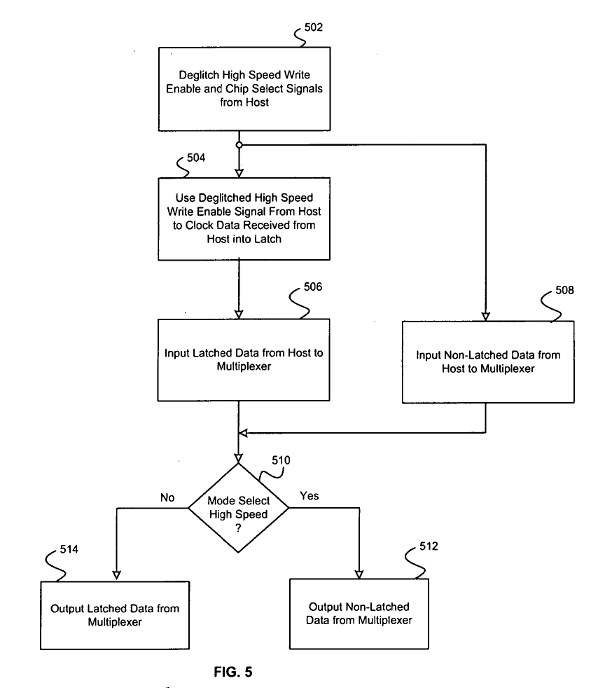

FIG. 5 is a flow chart illustrating exemplary steps for mobile multimedia processor circuitry supporting data latching and mode selection, in accordance with an embodiment of the invention. Referring to FIG. 5, in step 502, high speed write enable and chip select signals from the host 202 (FIG. 2) may be deglitched. In step 504, the deglitched high speed write enable signal from the host 202 may be utilized to clock data received from the host into the latch 404 (FIG. 4). In step 506, the latched data from the host 202 may be input to the multiplexer 406. In step 508, which may follow step 502, the non-latched data from the host 202 may also be input to the multiplexer 406. Step 510 may determine whether the output of the multiplexer is communicated to a high speed interface or a low speed interface. In step 512, the output is to be communicated to a high speed interface, and the mode input may enable the multiplexer 406 to output the non-latched data as the signal d_out. In step 514, the output is to be communicated to a low speed interface, and the mode input may enable the multiplexer 406 to output the latched data as the signal d_out.

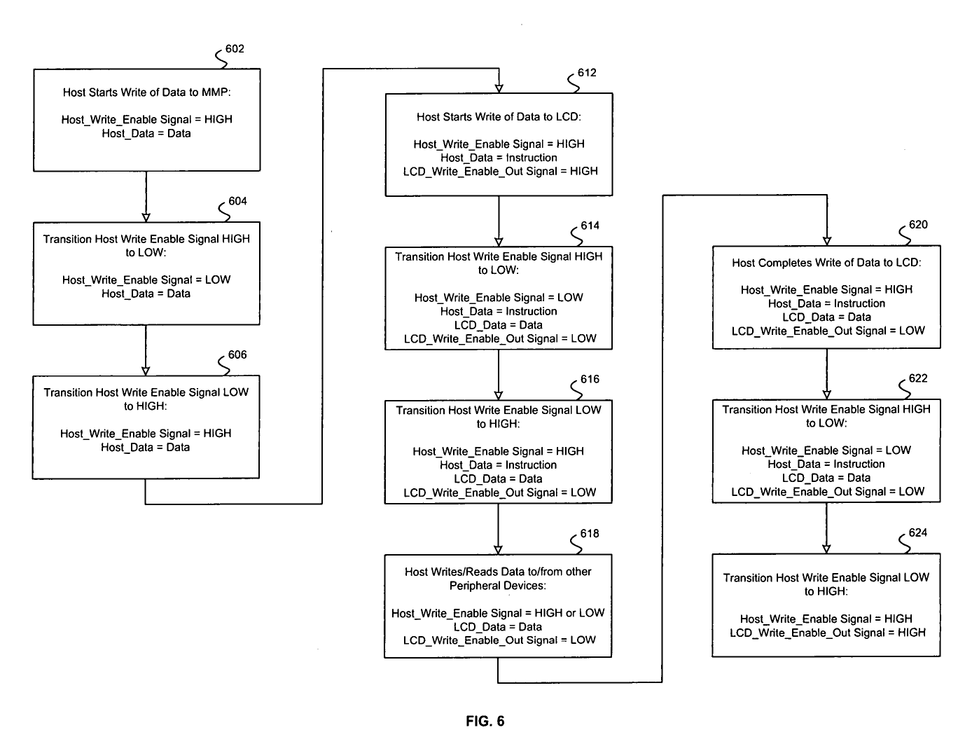

FIG. 6 is a flow chart illustrating exemplary steps for generating signals supporting data latching, in accordance with an embodiment of the invention. Referring to FIG. 6, in step 602, the host 202 may start a write of data to the mobile multimedia processor 204. The host write enable signal may be set to logic level HIGH and the host data signal may comprise data. In step 604, the host write enable signal may transition from logic level HIGH to logic level LOW. In response, the data may be stored in the mobile multimedia processor 204. In step 606, the host write enable signal may transition from logic level LOW to logic level HIGH. In step 612, the host 202 may start of write of data to the LCD 206. The host write enable signal may be set to logic level HIGH, the host data signal may comprise an instruction, and the LCD write enable out signal may be set to logic level HIGH. In step 614, the host write enable signal may transition from logic level HIGH to logic level LOW. In response, the host data signal may comprise the instruction, the LCD data signal may comprise the data previously written to the mobile multimedia processor 204, and the LCD write enable out signal may be set to logic level LOW. In step 616, the host write enable signal may transition from logic level LOW to logic level HIGH. The LCD data signal may continue comprise data, and the LCD write enable out signal may continue to be set to logic level LOW. In step 618, the host 202 may write or read data to or from other peripheral devices. The host write enable signal may be at logic level LOW or logic level HIGH. The LCD data signal may continue comprise data, and the LCD write enable out signal may continue to be set to logic level LOW.

In step 620, the host 202 may complete a write of data to the LCD 206. The host write enable signal may be set to logic level HIGH, the host data signal may comprise a subsequent instruction, the LCD data signal may continue to comprise data, and the LCD write enable out signal may continue to be set to logic level LOW. In step 622, the host write enable signal may transition from logic level HIGH to logic level LOW. The LCD data signal may continue to comprise data, and the LCD write enable out signal may continue to be set to logic level LOW. In step 624, the host write enable signal may transition from logic level LOW to logic level HIGH. In response, the LCD write enable out signal may transition from logic level LOW to logic level HIGH. The write of the LCD 206 by the host 202 may be completed.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for generating an address in a mobile multimedia processor, the method comprising:
latching, in a mobile multimedia processor, a received address signal, received at a received clock rate, via a received write enable signal;
converting, in said mobile multimedia processor, said received clock rate to a latched clock rate; and
generating, in said mobile multimedia processor, and at said latched clock rate, a latched address signal corresponding to said received address signal, via a latched write enable signal.

2. The method according to claim 1, wherein said received clock rate comprises a higher clock rate than said latched clock rate.

3. The method according to claim 1, further comprising latching a current binary value of said received address signal at a current time instant based on a corresponding current binary value of said received write enable signal.

4. The method according to claim 3, further comprising generating a current binary value of said latched address signal based on said current binary value of said received address signal.

5. The method according to claim 4, further comprising maintaining said current binary value of said latched address signal for a time duration based on a corresponding current binary value of said latched write enable signal.

6. The method according to claim 1 further comprising detecting a change in a current binary value of said received write enable signal at a current instant in time.

7. The method according to claim 6, further comprising generating a change in a corresponding current binary value of said latched write enable signal based on said detected change in said current binary value of said received write enable signal.

8. The method according to claim 7, further comprising maintaining a subsequent value of said latched write enable signal, generated based on said generated change in said corresponding current binary value of said latched write enable signal, for a time duration based on said latched clock rate.

9. The method according to claim 8, further comprising generating a subsequent change in said subsequent value of said latched write enable signal at a time instant subsequent to an end of said time duration based on said latched clock rate in response to a subsequent change in said received write enable signal.

10. The method according to claim 1, further comprising selecting one of: said received address signal, and said latched address signal, based on a mode signal.

11. The method according to claim 10, further comprising communicating said selected one of: said received address signal, and said latched address signal, to external circuitry.

12. A system for generating an address in a mobile multimedia processor, the system comprising:
circuitry that latches, in a mobile multimedia processor, a received address signal, received at a received clock rate, via a received write enable signal;
said circuitry converts, in said mobile multimedia processor, said received clock rate to a latched clock rate; and
said circuitry generates, in said mobile multimedia processor, and at said latched clock rate, a latched address signal corresponding to said received address signal, via a latched write enable signal.

13. The system according to claim 12, wherein said received clock rate comprises a higher clock rate than said latched clock rate.

14. The system according to claim 12, wherein said circuitry latches a current binary value of said received address signal at a current time instant based on a corresponding current binary value of said received write enable signal.

15. The system according to claim 14, wherein said circuitry generates a current binary value of said latched address signal based on said current binary value of said received address signal.

16. The system according to claim 15, wherein said circuitry maintains said current binary value of said latched address signal for a time duration based on a corresponding current binary value of said latched write enable signal.

17. The system according to claim 12 wherein said circuitry detects a change in a current binary value of said received write enable signal at a current instant in time.

18. The system according to claim 17, wherein said circuitry generates a change in a corresponding current binary value of said latched write enable signal based on said detected change in said current binary value of said received write enable signal.

19. The system according to claim 18, wherein said circuitry maintains a subsequent value of said latched write enable signal, generated based on said generated change in said corresponding current binary value of said latched write enable signal, for a time duration based on said latched clock rate.

20. The system according to claim 19, wherein said circuitry generates a subsequent change in said subsequent value of said latched write enable signal at a time instant subsequent to an end of said time duration based on said latched clock rate in response to a subsequent change in said received write enable signal.

21. The system according to claim 12, wherein said circuitry selects one of: said received address signal, and said latched address signal, based on a mode signal.

22. The system according to claim 21, wherein said circuitry communicates said selected one of: said received address signal, and said latched address signal, to external circuitry.
